(19) United States
(12) Patent Application Publication
(10) Pub. No.: US 2012/0141776 A1
(43) Pub. Date: Jun. 7, 2012

(54) SYSTEMS AND METHODS OF CREATING SPARKLE EFFECT IN EXTERIOR VEHICLE PAINT AND USING GLASS FLAKE

(75) Inventors: Fairuz Jane SCHLECHT, Newport Beach, CA (US); Marcus Leo SCHOLTEN, Irvine, CA (US)

(73) Assignee: Fisker Automotive, Inc.

(21) Appl. No.: 13/287,592

(22) Filed: Nov. 2, 2011

Related U.S. Application Data
(60) Provisional application No. 61/409,561, filed on Nov. 3, 2010.

(51) Int. Cl. B32B 33/00; B05D 1/36

(52) U.S. Cl. 428/325; 427/204

(57) ABSTRACT

A method of applying paint to a panel for fainting a sparkle effect on the panel includes depositing a primer layer on a surface of the panel; depositing a base coat layer over the primer layer, the base coat layer defining a predetermined color; and applying a clear coat layer over the base coat layer, the clear coat layer including a plurality of glass flakes.

### CROSS REFERENCE TO RELATED APPLICATION

This application claims priority to and the benefit of U.S. Provisional Patent Application Ser. No. 61/409,561 filed Nov. 1, 2010.

### BACKGROUND

The present disclosure relates generally to vehicles, and particularly to systems and methods for making a desired sparkle effect in exterior paint for a vehicle using glass flakes.

Vehicles, such as motor vehicles, have exteriors formed of various panels that are painted one or more colors. Exterior color is one of several features selected by a user at the time of purchase. Often the user or purchaser of the vehicle selects the exterior color from the options available to them from the manufacturer. Often manufacturers provide base paint colors for repair and touch-up jobs to match the vehicles original color. Exterior vehicle paint requires a durable application to withstand the harsh environmental conditions associated with driving. The exterior paint on the vehicle can be exposed to severe weather conditions, such as extreme heat and cold as well as rain, snow, and other natural events. Moreover, the paint must withstand and maintain its color after exposure to environmental conditions at higher speeds and sunlight.

The finished painted surface of the vehicle is formed via a plurality of layers. Special paint and application processes are used to apply each paint layer to the exterior of the vehicle. Often the application is robotic using one or more paint guns. At least a clear coat layer is applied to the paint color layer to protect the paint and the color. Typical paint applications include a primer layer, a base paint layer and at least a coating layer.

Color design can be a significant factor in vehicle purchasing and marketing. Automakers can use market analysis to determine desired exterior vehicle colors and make those options available to the purchaser. Within a particular color palette, a user may have further options associated with a color effect. For example, metallic colors can be provided that offer a more shimmer effect as compared to a basic or solid color.

A metallic flake added to the paint, such as aluminum flakes, is commonly used to create a desired “shimmer” color effect. Using small aluminum flakes in the base paint can create a metallic effect. A vehicle with a desired shimmer appearance is painted with an aluminum flake containing base paint. Small flakes in the paint layer can create a more “metallic” look. Large flakes in the paint layer can create a more brilliant shimmer appearance. Large aluminum flake paint colors can be fabricated on an as-needed basis to create a more distinct and attractive look. This technique is often done for auto shows or for marketing purposes. It is difficult to recreate the effect associated with a large flake application on a large-scale basis. For example, paint having large flakes clogs the paint guns much faster than non-flake containing paints. Moreover, the increased abrasiveness from using such flakes wears out the paint guns much faster. This makes using paint with an increased percentage of flakes unfeasible. Heretofore, no cost-effective process or system exists for generating a large flake containing paint application for a vehicle on a mass production basis. Accordingly, these increased shimmer or brilliant colors are not available to the public at large as a basic color option. Moreover, the large flake or higher flake containing paints may result in an added repair issue. To touch-up a particular area with a flake containing base paint creates a high flake concentration at the repair area and does not match the original color. This makes paint matching too difficult and cumbersome.

### SUMMARY

Various embodiments of the present disclosure relate to a method of applying paint to a panel for forming a sparkle effect on the panel. The method includes, but is not limited to (any one or combination of): (i) depositing a primer layer on a surface of the panel; (ii) depositing a base coat layer over the primer layer, the base coat layer defining a predetermined color; and (iii) applying a clear coat layer over the base coat layer, the clear coat layer including a plurality of glass flakes.

In various embodiments, a paint application is provided that allows for a desired sparkle effect for different colors of a vehicle paint application. In various embodiments, the same sparkle application can be used for different paint colors for the exterior of the vehicle. In various embodiments, repair of exterior color of a vehicle is achievable for a sparkle color. In various embodiments, increased sparkle effect can be achieved on a large-scale application.

### BRIEF DESCRIPTION OF THE DRAWINGS

FIG. 1 is illustrates a vehicle having exterior paint with glass flakes according to various embodiments of the disclosure.

FIG. 2 is illustrates a multilayer paint application according to various embodiments of the disclosure.

### DETAILED DESCRIPTION

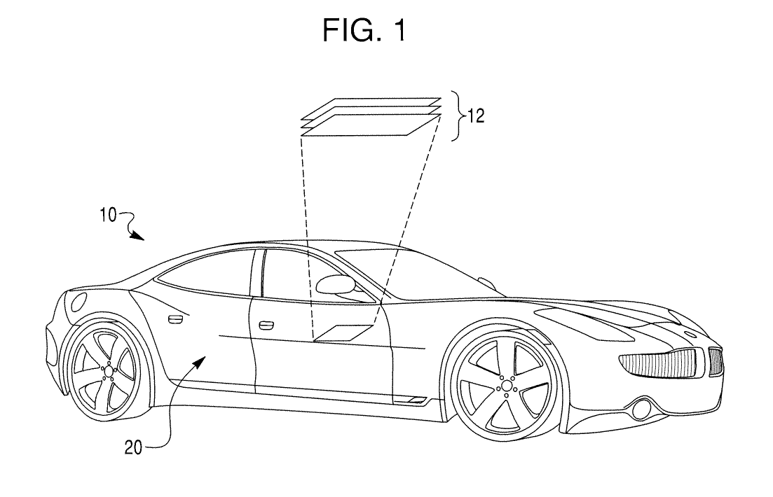

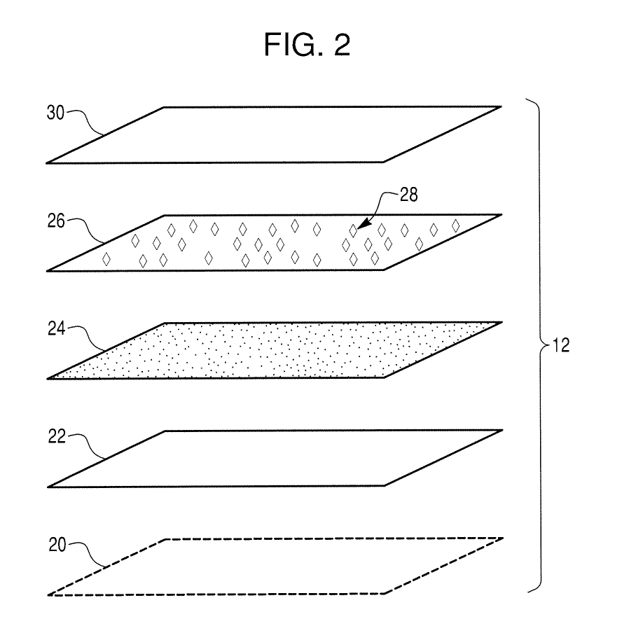

Referring to FIGS. 1-2, systems and methods for providing a sparkle effect on the exterior paint of a vehicle is provided. In some embodiments, a vehicle 10 includes a multilayer paint application 12 on an exterior surface 20 of the vehicle 10. The exterior surface 20 is defined on a exterior panel of the vehicle 10. The exterior panel of the vehicle may be made of metal, plastic, composite, and/or the like. In particular embodiments, the vehicle 10 is a motor vehicle. In other embodiments, it is understood that the paint application of the present disclosure can be applied to various other applications such as recreational vehicles, motorcycles, boats, or aerospace applications, as well as non-vehicles.

The multilayer paint application 12 includes multiple layers applied to a substrate surface. The substrate surface is typically the exterior metallic or composite surface 20 of the vehicle 10, for example. Existing products promoting a sparkle effect for exterior paint cannot provide a desirable level of intensity as compared to the present disclosure. Increasing glass flake composition in the base coat paint has been difficult due to paint gun processing issues. For example, the increased abrasiveness of the paint cause the paint guns to clog or wear out more quickly. The increase of glass flake ratio in paint color can be accomplished by increasing the size of the individual flakes or by increasing the amount of smaller flakes in a matrix substance. Both result in processing issues.

In various embodiments, the multilayer paint application 12 includes a primer layer 22, a base coat layer 24, and a clear coat layer 26 having glass flakes 28. In some embodiments, the multilayer paint application also includes at least a top clear coat layer 30. The primer layer 22 can be a paint product that allows finishing paint (e.g., the base coat 24) to adhere much better to the exterior surface 20 of the vehicle 10 than if the base coat 24 were used alone. Thus, in particular embodiments, the primer layer 22 can be designed to adhere to surfaces (e.g., the exterior surface 20) and to form a binding layer that is better prepared to receive the paint of the base coat layer 24. In some embodiments, because primers do not need to be engineered to have durable, finished surfaces, the primer layer 22 can be selected or designed to have improved filling and binding properties with the material underneath (e.g., the exterior surface 20). In some embodiments, this is achieved with specific chemistry, as in the case of aluminum primer, for example. In other embodiments, this is achieved through controlling the physical properties of the primer layer 22, such as porosity, tackiness, and hygroscopy. In paint applications in which the surface will be exposed to moisture, such as in the case of vehicles, primers can serve a protective function to help prevent exposing metallic portions of the exterior surface to moisture, which can cause oxidation. In some embodiments, the primer layer 22 can be tinted to a close match with the color of the base coat layer 24. If the finishing paint is a deep color, tinting the primer layer 22 can reduce the number of layers of the base coat layer 24 applied for good uniformity across the painted surface.

After the primer layer 22 is deposited over the exterior surface 20, the base coat layer 24 is then deposited over the primer layer 22. The base coat layer 24 defines a preselected color for the vehicle 10. Typically, a vehicle is available to a consumer in a variety of colors selectable as an option. These colors are defined in the base coat layer 24. For example, a vehicle can be offered in solid black or metallic black. Metallic black typically exhibits a more “shimmer” appearance. A manufacturer may purchase or produce large quantities of different colors of the base coat layer 24 for large-scale applications (e.g., a large fleet of vehicles). The paint may also be used for repair and touch-up work for aftermarket service in addition to the original factory application.

A purchaser of the vehicle having a particular color base coat may want to ensure that the color is matched to the original factory color when repairs are needed. Color matching can be difficult in repair and touch-up situations. It is increasingly difficult when the paint is not provided from the factory color associated with the original paint of the vehicle. If the color of the vehicle is a metallic or shimmer color, matching can provide further difficulties. One particular issue is that the shimmer or sparkle effect is overly concentrated in the repair spot on the vehicle. Moreover, base paints comprising aluminum flake that creates a shimmer or sparkle effect can clog the paint guns, thus restricting the degree of concentration and ability to generate more sparkle or higher shimmer colors.

Accordingly, in various embodiments, the glass flakes 28 are provided in the paint application 12. In particular embodiments, the glass flakes 28 are distributed in the clear coat layer 26. A particular difference over aluminum flakes is the degree of sparkle provided by the glass flakes 28. Aluminum flakes yields a more metallic appearance whereas glass flakes form a more brilliant sparkle appearance. A ratio of glass flakes 28 in a substance generates different sparkle effects. Accordingly, the more glass flakes 28 provided in the clear coat layer 26, the more sparkle is achieved. Moreover, as the concentration of the glass flakes 28 increases, the color of the multilayer paint application 12 changes to a different color or tint, which can be a further desirable color option. In some embodiments, the glass flakes 28 may comprise pieces of gold-coated glass.

In various embodiments, the glass flake concentration in the clear coat layer 26 can be adjusted based on the desired sparkle effect. In an example, the percentage (or concentration) of glass flakes 28 in the clear coat layer 26 can be higher than 1%. In a further example, the clear coat layer 26 may have a concentration of glass flakes 18 above 30%. In yet an even further example, the clear coat layer 26 may have a concentration of glass flakes 28 between 35-40%.

In various embodiments, the glass flakes 28 can be formed to be relatively larger than typical aluminum flakes. According to various embodiments, close attention must be paid to an application process when using large flakes. For example, when a coating has to be sprayed, the gun tip size is limited by several factors and the flake will have to be small enough to pass through the spray tip. Flakes with a nominal screen dimension across the flake (“SDAF”) of around 500 μm and below can be used for spray application and flakes above this size (e.g., SDAF between 500 μm and 1500 μm are less commonly used except for hand-applied materials. A further consideration for large flakes is surface disruption and in consequence large flakes tend to produce rough surface finishes. In this example, application of an additional clear coat top layer (e.g., the top clear coat layer 30) achieves a high-gloss finish suitable in the automotive industry. In some embodiments, flakes of different SDAF are blended. For example, a quantity of micronized (average diameter 30 μm) flakes may be combined with large flakes (e.g., SDAF between 50 μm and 500 μm).

Flake size and thickness are two considerations involved in performance. Quantity of glass flakes 28 added and particle distribution can further affect the result of the look of the paint application 12. For example, when thin glass flakes are used there are many more flakes than if thick ones are used for the same weight added. Therefore the surface area to be wetted with the thin flake is vastly greater. The glass flake application is suitable as a robot application. The robot can be programmed with a constant speed, distance to substrate and pressure. For end of line repair, a clear coat application (e.g., a second clear coat layer) can be applied that incorporates micronized and some larger flake to appear the same as the robot application.

The combination of flakes of different sizes and thicknesses along with the implementation of the different paints required (e.g., high bake for Body In White (“BIW” application) and low bake for plastic and non-metals) provides a suitable application for glass flake paint process. High bake can be a paint process used at an assembly facility as the paint is cured on the vehicle at about 180° C. Low bake can be a process used by suppliers of plastic parts and cure at about 80° C.

In various embodiments, the glass flakes 28 can be relatively invisible or transparent. Accordingly, a size of the individual glass flakes may be increased to achieve a suitable barrier effect. For instance, in some embodiments, the glass flakes 28 may have an aspect ratio of at least 10:1 to achieve a suitable barrier effect. Higher aspect ratios may achieve higher barrier effects.

The clear coat layer 26 can be the same for all base coat colors the manufacturer makes available. Example colors defining a sparkle effect of a 35-40% glass flake 28 in the clear coat layer 26 include but are not limited to: deep ocean—a sparkle grey/blue color; shadow—a sparkle light grey color; earth—a sparkle dark gray color; and silver wind—a sparkle brilliant silver color. This can reduce costs as the basic painting facilities and machineries can remain unchanged. Application of the clear coat layer 26 having glass flakes 28 can be applied to provide a desired sparkle effect for different base coat colors. Accordingly, multiple colored vehicles can be painted and then pass through identical clear coat applications and/or processes. This further reduces cost and improves efficiency in repair and touch-up since different base coat colors can be treated with an identical clear coat application. Color matching is achievable without depositing concentrated glass flake base paint into a particular area on the surface 20 of the vehicle 10. Buffing with the clear coat layer 26 having glass flakes 28 matches factory paint of the vehicle 10 more suitably than having the glass flakes 28 in the base coat 24. Moreover, different vehicle makers can use their own color matching or designs for the base coat 24 while requiring very few clear coat application systems.

In an example, the systems and methods of the present disclosure can be applied to hybrid vehicles such as partial hybrid electric vehicles or fully electric vehicles. The hybrid vehicle may include other features conventionally known for a vehicle, such as a motor, other controllers, a drive train, or the like.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of applying paint to a panel for forming a sparkle effect on the panel, the method comprising the steps of:
depositing a primer layer on a surface of the panel;
depositing a base coat layer over the primer layer, the base coat layer defining a predetermined color; and
applying a clear coat layer over the base coat layer, the clear coat layer including a plurality of glass flakes.

2. The method of claim 1, wherein the glass flakes have a predetermined concentration in the clear coat layer to provide a predetermined sparkle effect.

3. The method of claim 1, wherein the glass flakes comprises a metal-coated glass.

4. The method of claim 3, wherein the glass flakes comprise gold-coated glass.

5. The method of claim 1, wherein a percentage of the glass flakes in the clear coat layer is at least 1%.

6. The method of claim 1, wherein the glass flakes have a nominal screen dimension across the flake of between 50 μm and 500 μm.

7. The method of claim 1, wherein the glass flakes have a screen dimension across the flake of more than 500 μm.

8. The method of claim 1, wherein the glass flakes include at least some flakes having a nominal screen dimension across the flake within a first range and at least some flakes having a nominal screen dimension across the flake within a second range that does not overlap the first range.

9. The method of claim 1, wherein the glass flakes have a predetermined concentration in the clear coat layer.

10. The method of claim 1, further comprising the step of providing an additional clear coat layer over the clear coat layer and the glass flakes.

11. The method of claim 1, further comprising the step of curing the layers.

12. The method of claim 1, wherein the glass flakes have an aspect ratio of at least 10:1.

13. The method of claim 1, wherein the color coat later and the glass flakes are applied with a paint gun.

14. The method of claim 1, wherein the primer layer has greater binding properties with the surface of the panel than the base coat layer has with the surface of the panel.

15. The method of claim 1, further comprising the step of tinting the primer layer to closely meter the predetermined color.

16. A paint application for a panel for forming a sparkle effect on the panel, the paint application comprising:
a primer layer deposited on a surface of the panel;
a base coat layer deposited over the primer layer, the base coat layer defining a predetermined color; and
a clear coat layer applied over the base coat layer, the clear coat layer including a plurality of glass flakes.
